(19) United States
(12) Patent Application Publication
(10) Pub. No.: US 2020/0109078 A1
(43) Pub. Date: Apr. 9, 2020

(54) CAPILLARY TUBE AND METHOD OF PRODUCING THE SAME

(71) Applicant: Heraeus Quarzglas GmbH & Co. KG, Hanau (DE)

(72) Inventors: Stefan Weidlich, Mainz (DE); Clemens Schmitt, Blankenbach (DE); Joerg Werner, Altenstadt (DE)

(73) Assignee: Heraeus Quarzglas GmbH & Co. KG, Hanau (DE)

(21) Appl. No.: 16/597,399

(22) Filed: Oct. 9, 2019

(30) Foreign Application Priority Data
Oct. 9, 2018 (EP) 18 199 287.6

(51) Int. Cl. C03B 37/15

(52) U.S. Cl. CPC C03B 37/15; C03B 2205/16; C03B 2205/30; C03B 2203/32

(57) ABSTRACT

A method of producing a capillary tube from glass includes zonally softening a tubular preform having an outer diameter D_{OD}, an inner diameter D_{ID} and a diameter ratio Dᵣₑₗ—with Dᵣₑₗ=D_{OD}/D_{ID}—in a heating zone heated to a draw temperature T_{draw} and drawing off continuously from the softened region a capillary strand having an outer diameter d_{AD}, an inner diameter d_{ID} and a diameter ratio dᵣₑₗ—with dᵣₑₗ=d_{OD}/d_{ID}—at a draw speed v_{draw} and cutting the capillary to length therefrom. For cost-effective production of a thick-walled capillary by drawing from a preform without strict requirements for the geometry and dimensional accuracy of the preform, the capillary bore is subjected in the heating zone to a shrinkage process based on the action of draw temperature T_{draw} and surface tension, such that the diameter ratio dᵣₑₗ of the capillary strand is adjusted to a value greater than the diameter ratio Dᵣₑₗ of the preform by at least a factor of 5.

### CROSS-REFERENCE TO RELATED APPLICATION

This Utility patent application claims priority to European Application No. 18 199 287.6 filed on Oct. 9, 2018, which is incorporated herein by reference.

### TECHNICAL FIELD

One embodiment relates to a method of producing a capillary tube from glass, comprising a method step in which a tubular preform having an outer diameter D_{OD}, an inner diameter D_{ID} and a diameter ratio Dᵣₑₗ—with Dᵣₑₗ=D_{OD}/D_{ID}—is zonally softened in a heating zone heated up to a draw temperature T_{draw}, and a capillary strand having an outer diameter d_{OD}, an inner diameter d_{ID} and a diameter ratio dᵣₑₗ—with dᵣₑₗ=d_{OD}/d_{ID}—is drawn off continuously from the softened region at a draw speed v_{draw} and the capillary tube is cut to length therefrom.

Furthermore, one embodiment concerns a capillary tube made of glass having an outer diameter d_{OD} and an inner diameter dm.

Such capillary tubes are distinguished by a small inner diameter of e.g. less than 5 μm.

### BACKGROUND

The production of capillary tubes takes place e.g. by drawing a capillary strand from a glass melt or—where there are stricter requirements in terms of dimensional accuracy—by drawing (elongating) a tubular semi-finished product, such as e.g. a glass preform or a coaxial arrangement of glass components. The terms “capillary strand” and “capillary fiber” are used as equivalents here. From the “capillary strand” of the “capillary fiber”, capillary tubes or capillary fibers are cut to length.

An advantage of this drawing method is that a capillary strand of great length is obtained, from which a large number of capillary tubes can be cut to length. For some applications, particularly thick-walled capillary tubes are advantageous, for example when the dimensional accuracy and mechanical strength of the capillary tube are important.

The production of particularly thick-walled capillary tubes takes place according to EP-A1 259 877 by arranging multiple glass tubes with different diameters one inside another, the individual inner and outer diameters of these glass tubes being adapted to each other. The coaxial assembly of the glass tubes is heated and the individual tubes are fused together while being elongated. This method requires high outlay for the precise fabrication and clamping of the glass tubes in order to achieve a homogeneous fusing together of the tubes and a uniform capillary bore.

The ratio of inner diameter to outer diameter, which is also referred to for short as the “diameter ratio”, is generally already set in the semi-finished product from which the capillary is drawn. In other words, the capillary strand displays the same diameter ratio as the preform or the coaxial assembly of the nested tubes from which it is drawn. This is also known as a “ratio draw”.

To produce a capillary having a larger diameter ratio than the semi-finished product, DE 198 56 892 C2 proposes that a reduced pressure compared with the outside pressure be generated and maintained in the capillary bore during the drawing process. In this way, by elongating a quartz glass hollow cylinder, a tubular strand is produced in which the diameter ratio is greater than that of the initial hollow cylinder by a factor of 1.185 in one exemplary embodiment and by a factor of 1.344 in another exemplary embodiment.

It is known from WO 2014/141168 A1 that cavities in glass shrink as a result of irradiation with high-energy particles, such as photons or ions.

JP H08 157227 A describes a method of producing a capillary tube with a very small inner diameter for filling with a medium displaying the Kerr effect. The capillary tubes are obtained by elongation of a preform. The preform is extruded from the melt from a low-melting-point lead or phosphate glass.

Designs for optical glass fibers are known from EP 1 884 808 A2 which overcome the problem of self-induced damage by self-focusing. The refractive index of this fiber design is grossly non-uniform in the center core of the glass fiber. In one embodiment the glass fiber is designed with a deliberate and steep core trench. In addition, the nominal core region of these glass fibers has a very large area. The combination of these two properties restricts a large portion of the optical power envelope to a core ring, with reduced optical power inside the core ring where the optical intensity is highest. Since a high optical intensity raises the local refractive index, the core ring serves as a pseudo-core, where the bulk of the light is guided, and which further inhibits optical energy from entering the center of the core.

JP H04 342430 A describes the production of a capillary tube from quartz glass, in which the inner diameter is between 0.5 and 6.0 μm and the outer diameter is 600 to 2000 times the inner diameter. Here, a rod-shaped glass preform is provided from one end with a central longitudinal hole, which is connected to a transverse hole extending from the outer cladding surface. During elongation, air is introduced into the longitudinal hole via the transverse hole.

JP H03 8733 A describes the production of a quartz glass capillary with uniform inner and outer diameters. Here, an initial quartz glass tube is elongated to form a capillary with a constant outer diameter and is wound on to a winding reel, a vertical force being measured by a load cell. The inner diameter of the capillary calculated here is used to control the heating temperature or draw speed of the capillary.

The smaller the capillary bore, the stricter are the dimensional accuracy requirements for the semi-finished product. In capillary tubes with a small inner diameter of the bore of e.g. 2 μm, the dimensional accuracy requirements for the semi-finished product are already very strict, particularly if a high diameter ratio of e.g. more than 100 is desired at the same time; such capillary tubes are also referred to below as “thick-walled”. In the production of thick-walled capillary tubes with even smaller inner bores, e.g. of less than 1 μm, the known methods and auxiliary measures reach their limits, particularly where there are strict requirements relating to the quality and dimensional accuracy of the capillary bore.

### SUMMARY

One embodiment is therefore based on the object of specifying a method that allows the cost-effective production of a thick-walled capillary by drawing from a preform, without strict requirements for the geometry and dimensional accuracy of the preform.

Furthermore, one embodiment is based on the object of providing a thick-walled capillary that is distinguished by high quality of the capillary bore.

With regard to the method, this object is achieved according to one embodiment, starting from a method of the type mentioned above, by the fact that the capillary bore is subjected in the heating zone to a shrinkage process based on the action of draw temperature T_{draw} and surface tension in such a way that the diameter ratio dᵣₑₗ of the capillary strand is adjusted to a value greater than the diameter ratio Dᵣₑₗ of the preform by at least a factor of 5, wherein a multimode optical fiber preform or a single-mode optical fiber preform with a preform core surrounding an inner bore and a preform cladding covering the preform core is employed as the preform, and a capillary strand is drawn therefrom having a capillary core surrounding a capillary bore and a capillary cladding covering the capillary core.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a diagram to explain the relationship of the shrinkage of the capillary bore in the fiber drawing process as a function of the draw temperature.

FIG. 2 is an embodiment of a glass capillary according to one embodiment in a top view of an end face in a schematic illustration.

FIG. 3 is a diagram of the shrinkage behavior of the capillary bore of the capillary according to FIG. 2 as a function of the draw temperature.

FIG. 4 is a scanning electron microscope image of the capillary at an early stage of the fiber drawing process.

FIG. 5 is a scanning electron microscope image of the capillary of FIG. 4 in a higher magnification.

FIG. 6 is a scanning electron microscope image of a capillary on completion of the fiber drawing process.

### DETAILED DESCRIPTION

In the following Detailed Description, reference is made to the accompanying drawings, which form a part hereof, and in which is shown by way of illustration specific embodiments in which the embodiments may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the embodiments. The following detailed description, therefore, is not to be taken in a limiting sense, and the scope of the embodiments is defined by the appended claims.

It is to be understood that the features of the various exemplary embodiments described herein may be combined with each other, unless specifically noted otherwise.

In the known drawing methods, the adjustment of the geometry of the capillary bore is based substantially on the preform specifications and on the choice of pressures inside and outside the capillary bore during the drawing process. In contrast, in the method according to one embodiment, the adjustment of inner diameter and diameter ratio of the capillary is substantially independent of the preform and of pressures inside and outside the capillary bore, but it is crucially based on the effect of surface tension on the capillary bore in the hottest zone during the drawing process. This is because the capillary bore shrinks under the effect of surface tension during the drawing process, the degree of shrinkage caused by the action of surface tension being dependent on the viscosity of the glass in the region of the capillary bore. The lower the viscosity and the longer the surface tension can exert its shrinking effect on a low-viscosity glass, the greater the influence of surface tension in determining the size and shape of the capillary bore obtained in the heating zone.

The surface tension also necessarily has an effect in the known drawing methods; however, the degree of shrinkage that it causes is limited and is overlaid with other mechanisms of action, such as pressure or drawing forces, which are crucial in determining the adjustment of the capillary bore's geometry in the known drawing methods whereas the surface tension is not.

The viscosity in the heating zone is adjusted by a complex interaction of, in particular, the draw temperature, which is comparatively high, and the draw speed, which is comparatively low. By carefully and gradually raising the draw temperature and/or reducing the draw speed, the person skilled in the art can increase the degree of shrinkage that is based on the effect of surface tension during the drawing process.

Since the inner diameter of the capillary bore is reduced by the crucial effect of surface tension to a greater extent in the fiber drawing process than in a pure ratio draw, the diameter ratio dᵣₑₗ increases. Within the framework of this embodiment it is considered as a measure of the fact that the viscosity in the region of the heating zone is such that the surface tension is crucial in determining the adjustment of the capillary bore geometry that the diameter ratio dᵣₑₗ of the capillary strand can be adjusted to a value greater than the diameter ratio Dᵣₑₗ of the preform by at least a factor of 5. This is because this significant difference in the diameter ratios of preform and capillary would be very difficult to achieve without the crucial effect of surface tension in the absence of other special measures. The effect of surface tension on the adjustment of the capillary bore's inner diameter is all the more decisive the greater the dᵣₑₗ/Dᵣₑₗ ratio, and so this ratio is advantageously at least 10, in one embodiment at least 20 and in one embodiment at least 50.

In one embodiment, the geometry of the capillary bore is crucially adjusted by the effect of surface tension, so the significance of other parameters that are normally considered to be decisive in adjusting the capillary bore geometry, such as e.g. the pressure difference between the pressures inside and outside the capillary bore and the geometric specifications on the part of the preform, fades into the background. In particular, as a result, the dimensional accuracy requirements for the preform are comparatively less strict and so the production process can be made cost-effective even for thick-walled capillary tubes with a small capillary bore. The production of the capillary tubes by drawing from a preform allows the cost-effective fabrication of identical capillary sizes in large quantities.

The method according to one embodiment can be employed particularly advantageously if the capillary tube has an inhomogeneous profile of the refractive index across its radius, as the radially inhomogeneous refractive index profile causes an equally radially inhomogeneous viscosity profile during the drawing process, which can make it more difficult to adjust a capillary bore to a predefined diameter. This difficulty can be minimized by employing the method according to one embodiment. It is therefore provided according to one embodiment that a multimode optical fiber preform or a single-mode optical fiber preform with a preform core surrounding an inner bore and a preform cladding covering the preform core is employed as the preform, and a capillary strand is drawn therefrom which has a capillary core surrounding a capillary bore and a capillary cladding covering the capillary core.

From the capillary strand, capillaries are produced which are designed as multimode or single-mode fibers for light guiding.

In one embodiment of the method, the capillary core forms a cross-sectional area CSA_{VK} and the capillary cladding forms a cross-sectional area CSA_{KM}, a preform being employed in which the preform core has a cross-sectional area CSA_{VK} and the preform cladding has a cross-sectional area CSA_{VM}, wherein the following applies to the respective cross-sectional area ratios of cladding and core: CSA_{KM}/CSA_{KK}=CSA_{VM}/CSA_{VK}.

The capillary core has a different chemical composition to the capillary cladding. If the core consists of quartz glass, it is doped e.g. with a substance that increases the refractive index of quartz glass, such as e.g. germanium. In this case, the cladding can consist of undoped quartz glass or can be doped with a substance that lowers the refractive index of quartz glass. In this method variant of one embodiment, the ratio of the radii of core and cladding regions in the preform is not adjusted to the target value in the capillary tube—as is normally the case in a ratio draw—but the cross-sectional ratio of the two regions, the ratio of the respective so-called “cross-sectional areas” (CSA) in the preform, is set to the target value in the capillary. In other words, the CSA ratio in the preform is identical to the CSA ratio in the capillary.

During the drawing of the capillary strand, the predefined diameter of the capillary bore is adjusted so that the correspondingly desired ratio of outer diameter to inner diameter of the capillary tube, and thus the desired ratio of outer diameter to diameter of the core region, and thus the CSA ratio are also obtained automatically.

In this method variant, it is the ratio of the respective CSA regions that is predefined and not—as in ratio drawing—the diameter ratio. The advantage here is that CSA values can be constructed very accurately in advance, while the corresponding accuracy only has to be achieved for the diameters (or radii) in the fiber drawing process.

The above-mentioned careful and gradual approach for adjusting the desired level of influence of the surface tension during the drawing process takes place in a method variant by carefully raising the draw temperature until the actual draw temperature T_{draw} is reached. An iterative process is used to determine the draw temperature T_{draw} at which a reduction in size of the capillary bore is not based exclusively on elongation of the preform but at which shrinkage due to surface tension is initiated and causes the desired contribution to the size reduction. The iterative process in one embodiment includes the following method steps:
(a) The heating zone is heated to a temperature T₁, wherein T₁<T_{draw}.
(b) With the heating zone heated to the temperature T₁, a partial capillary strand is drawn.
(c) The capillary bore diameter of the partial capillary strand is determined and it is ensured that this is greater than a nominal inner diameter of the capillary bore.
(d) The temperature of the heating zone is raised from T₁ to a draw temperature T₂, and with the heating zone heated to the draw temperature T₂ a further partial capillary strand is drawn.
(e) The capillary bore diameter of the further partial capillary strand is determined and it is established whether the diameter lies within an acceptable fluctuation range of the nominal inner diameter.
(f) If the capillary bore diameter lies within the fluctuation range of the nominal inner diameter, T₂=T_{draw} applies; if the capillary bore diameter is greater than the nominal inner diameter, including the acceptable fluctuation range, T₂<T_{draw} applies and the iterative process is continued in method step (d) with the proviso that T₁=T₂; if the capillary bore diameter is less than the nominal inner diameter including the fluctuation range, T₂>T_{draw} applies and the iterative process is continued in method step (a).

The draw temperature T_{draw} is the temperature that, with the rest of the drawing parameters unchanged, causes a sufficiently low viscosity in the region of the heating zone that the desired level of influence of the surface tension, i.e. sufficient shrinkage of the capillary bore, is achieved.

To enable an iterative gradual approach to determining T_{draw} starting from a low temperature, a starting temperature T₁ that is lower than T_{draw} should be selected in method step (a) so that the capillary bore does not shrink sufficiently at first, and/or a capillary bore is maintained and does not collapse completely. This fact is checked in method step (b) by comparing the nominal inner diameter of the capillary bore with the measured value, corresponding to the value referred to above as d_{ID}.

In the simplest case it is known that T₁ is lower than T_{draw}, otherwise it is necessary to begin with a sufficiently low start temperature and proceed gradually.

In the subsequent method step, the temperature of the heating zone is brought from T₁ to a higher draw temperature T₂, and a check is again performed on a partial capillary strand drawn at the draw temperature T₂ to determine whether the capillary bore diameter is now within an acceptable fluctuation range of the nominal inner diameter. The temperature value T_{draw} at which the rest of the preform can be drawn to form the capillary strand may be found.

Otherwise—in the case of T₂<T_{draw}—the iterative process is continued in method step (d). In the nomenclature of method step (d) the temperature T₂ is formally regarded as T₁ and the draw temperature of the heating zone is raised by a further temperature level.

Otherwise—in the case of T₂>T_{draw}—a capillary bore is obtained which is too small or has collapsed completely. In this case, the temperature value T_{draw} has not been found in this test series, and the test series should therefore be repeated starting at method step (a) using other temperature values.

It has been shown that, in the iterative adjustment process explained above, temperature differences between T₁ and T₂ in the range of just a few degrees can have a significant influence on the capillary bore diameter.

By means of the iterative adjustment process described above, the optimum draw temperature for each preform can be found while maintaining the other drawing parameters. Preforms can differ from one another e.g. in terms of thermal conductivity and heat capacity and so the iterative adjustment process has to be performed individually. To minimize this effort, the individual preforms can be conditioned such that, as far as possible, they do not differ in their thermal conductivity and heat capacity values. A measure that is suitable for this purpose is e.g. grinding the preforms from one batch to a uniform final dimension.

Since the iterative adjustment process for the draw temperature is based on temperature differences and takes place in the actual drawing process, the location of the temperature adjustment and measurement is not important. For instance, the draw temperature T_{draw} and/or the intermediate values T₁ and T₂ can be adjusted and measured e.g. in the heating zone—for instance at a heating element—or on the capillary tube.

The determination of the capillary bore diameter using method steps (c) and (e) in one embodiment takes place during the drawing of the capillary strand or during the drawing of the “further capillary strand”. Advantageously here, the capillary strand passes through an optical microscope apparatus, by means of which the capillary bore diameter can be detected online. Alternatively, and equally preferably in one embodiment, a measuring sample is taken from the current partial strand and examined microscopically as quickly as possible to determine the capillary bore diameter while the drawing of the current partial strand is continued.

The iterative adjustment process for the optimum draw temperature described above can be similarly adapted for adjusting the optimum draw speed for each preform while maintaining the draw temperature T_{draw}. In this case, an iterative gradual approach can be employed starting from a draw speed v₁, which is initially too high and at which the capillary bore does not at first shrink sufficiently, by successively reducing the draw speed until the optimum draw speed v_{draw} is reached. In this case, at a constant heating zone temperature T_{draw}, an iterative process is used to determine the draw speed v_{draw} that ensures that the glass is exposed to the high temperature of the heating zone for sufficiently long and takes on a sufficiently low viscosity that a size reduction of the capillary bore is based not exclusively on preform elongation but the surface tension makes a crucial contribution to the shrinkage of the capillary bore. This iterative process includes the following method steps:
(a) The draw speed is adjusted to a value v₁, to which v₁>v_{draw} applies.
(b) At the draw speed v₁ a partial capillary strand is drawn.
(c) The capillary bore diameter of the partial capillary strand is determined and it is ensured that this is greater than a nominal inner diameter of the capillary bore.
(d) The draw speed is reduced from v₁ to a draw speed v₂, and at the reduced draw speed v₂ a further partial capillary strand is drawn.
(e) The capillary bore diameter of the further partial capillary strand is determined and it is established whether the diameter lies within an acceptable fluctuation range of the nominal inner diameter.
(f) If the capillary bore diameter lies within the fluctuation range of the nominal inner diameter, v₂=v_{draw} applies; if the capillary bore diameter is greater than the nominal inner diameter including the acceptable fluctuation range, v₂>v_{draw} applies and the iterative process is continued in method step (d) with the proviso that v₁=v₂; if the capillary bore diameter is less than the nominal inner diameter including the fluctuation range, v₂<v_{draw} applies and the iterative process is continued in method step (a).

As a guide to the draw speed v_{draw}, a value in the range of 5 to 100 m/min can be used as a suitable starting point.

In particular with regard to a cost-effective fabrication process, a technique is preferred in one embodiment in which the capillary strand is drawn off from the preform with a comparatively high elongation ratio in the range of 900 to 200,000.

The elongation ratio is calculated here as the ratio of the lengths of preform and capillary strand.

The geometric parameter ranges mentioned below have proved particularly advantageous for the preform to be elongated and for the capillary strand obtained therefrom by the method according to the embodiment:
D_{OD}>15 mm
D_{ID}>1 mm
Dᵣₑₗ<30
d_{OD}>100 μm
d_{ID}<1 μm
dᵣₑₗ>100

The following applies here in particular to the capillary strand:

100 μm < d_{OD} < 500 μm,
0.1 μm < d_{ID} < 1 μm and
100 < dᵣₑₗ < 5,000.

The following applies here in particular to the preform:

15 mm < D_{OD} < 45 mm,
1 mm < D_{ID} < 5 mm and
3 < Dᵣₑₗ < 30.

The following applies here in particular to the preform and the capillary strand:

2,000 < DID/dID < 50,000
dᵣₑₗ/Dᵣₑₗ > 10, in one embodiment > 20 and in particular > 50 and
dᵣₑₗ/Dᵣₑₗ < 300.

As explained above, the ratio dᵣₑₗ/Dᵣₑₗ is suitable as a criterion for the crucial effect of surface tension on the adjustment of the capillary bore. The greater the ratio value, the greater generally will be the portion of the capillary bore adjustment that is based on the effect of surface tension. In this regard, the ratio value dᵣₑₗ/Dᵣₑₗ is at least 5, in one embodiment at least 10, in another embodiment at least 20 and in another embodiment at least 50. In addition, the ratio value dᵣₑₗ/Dᵣₑₗ also represents a particular technical advantage of one embodiment which, as explained above, consists in the fact that, in contrast to what happens with the so-called “ratio draw”, which specifies a fixed correlation between the radial dimensions of preform and capillary, the capillary drawing process according to one embodiment permits an adjustment of wall thickness and capillary bore diameter that is largely independent of the radial dimensions of the preform. On the one hand this simplifies the production of the hollow cylindrical preform, in which e.g. the creation of a very small inner bore and/or a very large outer diameter are not required, and it allows capillaries with different geometries to be drawn from the same size of preforms. High ratio values dᵣₑₗ/Dᵣₑₗ of more than 300 represent capillary drawing processes with a particularly high degree of reshaping of the original preform wall by shrinkage of the capillary bore.

With regard to a homogeneous heating of the glass, it has proved expedient if the heating zone is formed in a tube furnace having a circular inner heating chamber.

The capillary tube according to one embodiment consists of glass, in particular of quartz glass, and it has an outer diameter d_{OD} and an inner diameter d_{ID}. The above-stated object is achieved according to one embodiment with regard to the capillary tube by the fact that it is obtained by the method according to one embodiment and has the following geometric dimensions:

100 μm < d_{OD} < 500 μm,
0.1 μm < d_{ID} < 1 μm and
100 < dᵣₑₗ < 5000, with dᵣₑₗ = d_{OD}/d_{ID}.

The capillary tube is obtained by cutting to length a capillary strand that has been produced by the method according to one embodiment. It is distinguished by a high wall thickness and a high quality of the capillary bore.

Capillary fibers are usually produced in a so-called “ratio draw”. This means that the geometric ratio of outer to inner diameter is already predefined in the semi-finished product (the preform), this being in accordance with the desired ratio in the capillary fiber that is drawn from the semi-finished product by thermal heating. For conventional inner diameters of capillary fibers, this ratio can already be produced in the preform with sufficient accuracy for capillary fiber drawing. For geometry values in which a very small inner diameter of less than about 2 μm is to be achieved in the capillary fiber, however, there are strict requirements for the necessary manufacturing tolerance of the preform.

In the method according to one embodiment, the fiber drawing process is not a ratio draw and so it is not the ratio of the respective radii of core and cladding of preform and capillary that is taken into account in designing the preform but the ratio of the CSA regions. The requirements regarding the geometry of the preform are therefore significantly less strict as a preform is produced with a CSA value that corresponds to that of the capillary tube in the event that this has the specified capillary bore diameter.

As already mentioned, it is not the radius ratio of the core and cladding region that is brought to the capillary's target value in the preform but rather the ratio of the cross-sections of the respective CSA regions, the target value being already set in the preform.

When the capillary strand is drawn, the capillary bore is collapsed to the desired inner diameter by shrinkage under the crucial influence of surface tension. As soon as the appropriate predefined ratio of outer diameter to inner diameter is reached in the capillary strand, the predefined CSA value is automatically also reached.

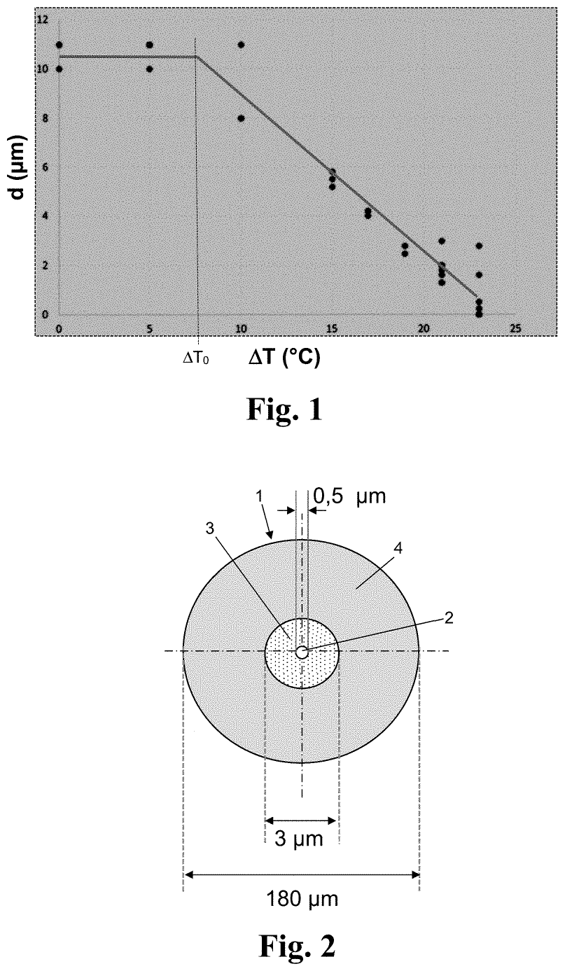

With reference to the diagram of FIG. 1, the procedure according to one embodiment for determining the draw temperature T_{draw} during the drawing of the capillary strand is first explained using the example of a preliminary test series with one preform batch. On the y-axis the diameter d of the capillary bore 2 (in μm) is plotted against a temperature increase ΔT (in ° C.) starting from a previously selected starting value of the draw temperature.

The diagram illustrates that the capillary bore diameter d, starting from a value of 10 nm, initially changes very little or not at all with a temperature increase of less than about 7° C. above the starting value (ΔT=0). In this parameter range—as is usual in a ratio draw—the capillary bore diameter d is adjusted primarily on the basis of the feed speed and draw speed. Only above a certain temperature increase ΔT₀, which is about 7° Celsius in this test series, is there an appreciable reduction in the capillary bore size, which scales almost perfectly with the further draw temperature increase. It is illustrated that the dependency of the diameter on the draw temperature is very sensitive and is a function of the thermal load or heat capacity and heat conduction of the preform. The deviations in the measuring points are substantially attributable to fluctuations in the thermal conductivity and heat capacity of the respective preform within the batch, and in particular to slightly different outer diameters of the respective preform. They can be avoided by grinding each preform in a batch to a predefined length and diameter dimension in advance.

The desired level of influence of surface tension in the drawing process is adjusted with the aid of an iterative technique by carefully raising the draw temperature until the optimum draw temperature T_{draw} is reached. To find the optimum draw temperature, samples are taken during the fiber drawing process to check the current diameter of the capillary bore and to readjust if necessary. The diameter of the capillary bore is referred to below as the “inner diameter” for short. The sampling, for instance by a scanning electron microscope, enables the adjustment to be checked and the draw temperature (more precisely: the furnace temperature) to be raised, e.g. in steps of 0.5° C., for a sufficiently long period until the inner diameter collapses to the desired value with the draw temperature adapted accordingly in the further fiber drawing process.

The iterative gradual approach requires an initial inner diameter that is too large, owing to “too cold drawing”. As illustrated by the diagram of FIG. 1, the further collapse of the inner diameter from ΔT₀ is a linear function of the increase in draw temperature. If the inner diameter has already collapsed completely, on the other hand, e.g. because the initial draw temperature selected was too high, the adjustment cannot take place with the aid of the linear relationship of FIG. 1 and so the fiber drawing process has to be repeated with a lower initial draw temperature.

It has been illustrated that, in the iterative adjustment process explained above, temperature differences in the range of just a few degrees already have a significant effect on the capillary bore diameter. By means of the iterative adjustment process, the optimum draw temperature can be found for each preform while maintaining the other drawing parameters.

When the optimum draw temperature is applied in the further fiber drawing process, the inner diameter shrinks under the crucial effect of surface tension and can be stabilized at a nominal value with a deviation of +/−50 nm.

FIG. 2 illustrates a schematic top view of the end face of a capillary 1 with the capillary bore 2. The capillary 1 is configured as a single-mode fiber for light guiding. It has a core 3 and a cladding 4 surrounding the core 3, wherein the refractive index of the core 3 is higher than the refractive index of the cladding 4, so that laser light is guided substantially in the core 3 by total internal reflection.

The capillary 1 has an outer diameter d_{OD} of 180 μm. The core 3 has a diameter of 3 μm, and the diameter d_{ID} of the capillary bore 2 is 0.5 μm. The diameter ratio dᵣₑₗ is thus 180 μm/0.5 μm=360 and the cross-section ratio of the CSA values of the capillary cladding and core is 25,439.8 μm²/6.9 μm²=3,687. FIG. 2 is not to scale for illustrative purposes. The capillary bore 2, the core 3 and the cladding 4 extend coaxially around the capillary's central axis.

The cladding 4 consists of synthetically produced, undoped quartz glass with a refractive index of 1.4607. This value is based on a measurement with a light wavelength of 532 nm and a measurement temperature of 20° C. These measurement conditions were also used for the refractive index values mentioned below. The core 3 consists of quartz glass which is doped with germanium. The difference in the refractive indices of the quartz glasses of core 3 and cladding 4 is 0.008.

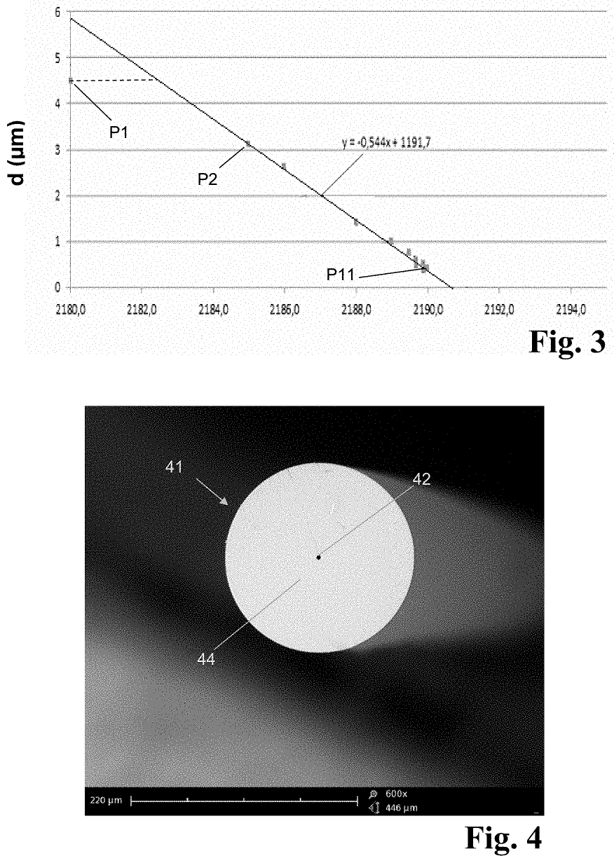

An exemplary technique for producing the capillary tube 1 illustrated schematically in FIG. 2 will be explained in more detail below with reference to FIGS. 3 to 6.

The capillary tube 1 is drawn from a preform with the following dimensions:

outer diameter D_{OD}>28.000 mm

inner diameter D_{ID}>2.052 mm

diameter ratio Dᵣₑₗ 13.644

core diameter: 2.102 mm

CSA ratio 3,749

Since the inner diameter shrinks to a greater extent during the fiber drawing process than would be the case with purely a ratio draw, the diameter ratio dᵣₑₗ of the capillary strand increases compared to that of the preform in the exemplary embodiment by a factor of approximately 27.

The fiber drawing process for the preform is characterized by the following starting parameters:

draw temperature T_{draw} approximately 2190° C.

draw speed v_{draw} 30 m/min

feed speed 1.53 mm/min

The draw temperature given here is the temperature of the wall of the annular drawing furnace which coaxially surrounds the preform and the capillary strand drawn therefrom during the fiber drawing process. The drawing furnace has a circular inner heating chamber with a heating length of 15 cm.

At the beginning of the fiber drawing process the above starting parameters are used, ensuring that the collapse does not yet take place to a sufficient degree and the resulting inner diameter is too large.

During the fiber drawing process, samples were taken continuously from the capillary strand and the current radial dimensions were determined by microscopy.

The diagram of FIG. 3 illustrates the development of the capillary's inner diameter d (in μm) as a function of the respective draw temperature T_{draw} (in ° C.). The nano-hole fiber 41 with the dimensions of FIG. 4 corresponds to the measuring point P1 at the draw temperature of 2,180° C. Starting from P1, the draw temperature T_{draw}, i.e. the temperature of the fiber drawing furnace, was successively raised in order to bring about a shrinkage of the capillary diameter during fiber drawing. It can be seen from the diagram that shrinkage of the capillary (nano-hole fiber 41) has started at the measuring point P2 with a 5° temperature increase to a draw temperature of 2185° C. The measuring point P2, like the last measuring point P11 of the test series, lies on a straight line, the linear equation of which is given in FIG. 3. At the measuring point P11, the nano-hole fiber 41 has reached its nominal inner diameter.

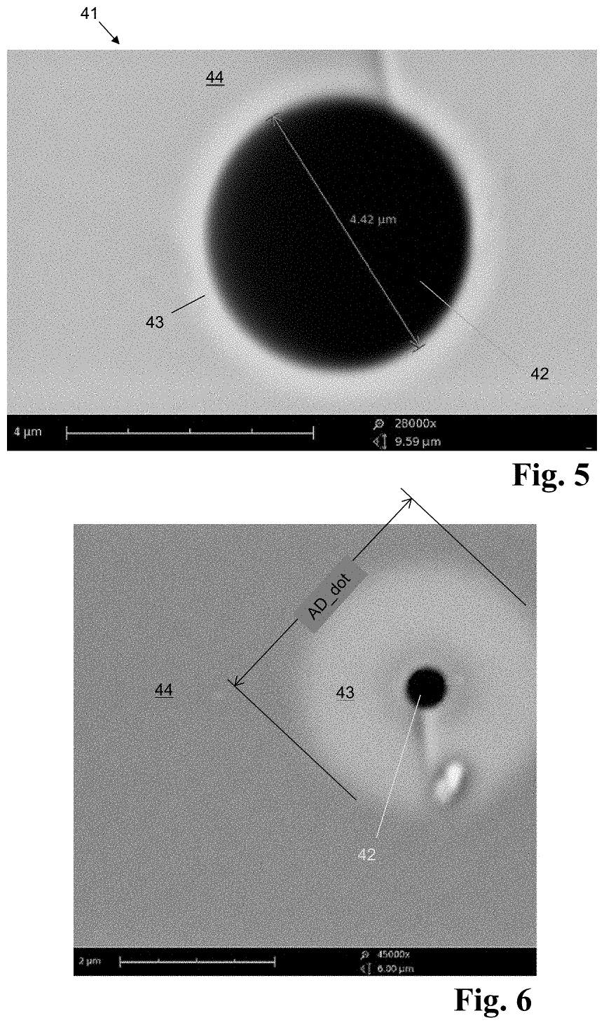

The scanning electron microscope images of FIGS. 4 to 6 illustrate this procedure. FIGS. 4 and 5 illustrate the so-called “nano-hole fiber” 41 at the initial stage of the fiber drawing process. The nano-hole fiber 41 has a capillary bore 42 with a nominal inner diameter “ID” of 500 nm, which is surrounded by a core region of Ge-doped quartz glass. The rest of the capillary material (the cladding 44) consists of undoped quartz glass. In contrast to the nominal outer diameter of 180 μm, which has already been reached at this stage of the process, the inner diameter of the capillary bore 42 is still much too large at 4.42 μm (FIG. 5).

The nano-hole fiber 41 is produced by elongating a preform in which the CSA ratio of doped to undoped region already corresponds to the desired ratio in the nano-hole fiber 41, provided that the nominal inner diameter of 500 nm has been reached. The core region (43) at this initial stage of the fiber drawing process, at which the adjustment by shrinkage of the capillary bore 42 with inner diameter ID has not yet started, is still very narrow, however, and cannot be seen in FIG. 4.

FIG. 5 illustrates the same nano-hole fiber 41 at a higher magnification. Next to the capillary bore 42 with an inner diameter ID of 4.42 μm, the doped core region 43 is now also visible as a bright ring (the core region 43 is also present in FIG. 4, but is too narrow to be visible there).

FIG. 6 illustrates the nano-hole fiber 41 associated with the measuring point P11. By this point, the furnace temperature of the drawing furnace has been raised in steps by a total of 9.7° C. compared to the measuring point P1 in order to increase the influence of surface tension and to further reduce the inner diameter of the capillary bore 42 under the effect thereof. It has now been brought to the nominal inner diameter of about 500 nm. The ratio of the outer diameter AD of the cladding 44 to the outer diameter AD_dot of the core region 43 and the ratio of the outer diameter AD of the cladding 44 to the diameter ID of the capillary bore 42 has now been adjusted to the target value according to the specifications after complete collapse of the bore 42.

The following table illustrates results of further test series in which capillaries with different capillary bore diameters have been drawn from preforms.

TABLE

| | | | | | |
|---|---|---|---|---|---|
| Preform | | | | | |
| Outer diameter DOD [mm] | 30.000 | 40.000 | 40.000 | 40.000 | 30.000 |
| Inner diameter DID [mm] | 2.970 | 3.740 | 2.581 | 2.578 | 1.675 |
| Diameter ratio Drel | 10.101 | 10.694 | 15.501 | 15.515 | 17.908 |
| Core diameter: | 3.102 | 3.906 | 2.597 | 2.597 | 1.691 |
| Diameter ratio core/cladding | 9.673 | 10.241 | 15.405 | 15.405 | 17.738 |
| CSA ratio (core/cladding) | 1115.636 | 1251.971 | 19145.156 | 16600.398 | 16544.139 |
| Fiber | | | | | |
| Outer diameter dOD [μm] | 100.00 | 100.00 | 400.00 | 400.00 | 400.00 |
| Inner diameter dID [μm] | 0.100 | 1.000 | 1.000 | 0.100 | 0.100 |
| Diameter ratio drel | 1000.000 | 100.005 | 400.001 | 4000.000 | 4000.000 |
| Core diameter: | 2.994 | 2.997 | 3.059 | 3.106 | 3.111 |
| Diameter ratio core/cladding | 33.397 | 33.370 | 130.767 | 128.780 | 128.561 |
| CSA ratio (core/cladding) | 1115.636 | 1251.971 | 19145.156 | 16600.398 | 16544.139 |
| Ratio (preform/fiber or | | | | | |
| fiber/preform) | | | | | |
| P/F: outer diameter | 300.000 | 399.980 | 100.000 | 100.000 | 75.000 |
| DOD/dOD | | | | | |
| P/F: inner diameter DID/dID | 29700.923 | 3740.465 | 2580.553 | 25780.803 | 16752.055 |
| F/P: diameter ratio drel/Drel | 99.003 | 9.352 | 25.806 | 257.808 | 223.361 |
| P/F: core diameter ratio | 1,035.835 | 1,303.376 | 848.881 | 835.982 | 543.594 |
| F/P: diameter ratio | 3.453 | 3.259 | 8.489 | 8.360 | 7.248 |
| core/cladding | | | | | |
| P/F: CSA ratio | 1000.000 | 1000.000 | 1000.000 | 1000.000 | 1000.000 |
| (core/cladding) | | | | | |

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

Therefore, it is intended that this invention be limited only by the claims and the equivalents thereof

What is claimed is:

1. A method of producing a capillary tube from glass, comprising:
zonally softening a tubular preform having an outer diameter D_{OD}, an inner diameter D_{ID} and a diameter ratio Dᵣₑₗ—with Dᵣₑₗ=D_{OD}/D_{ID}—in a heating zone heated to a draw temperature T_{draw};
drawning off continuously from the softened region a capillary strand having an outer diameter d_{OD}, an inner diameter d_{ID} and a diameter ratio dᵣₑₗ—with dᵣₑₗ=d_{OD}/d_{ID}—at a draw speed v_{draw}; and
cutting the capillary tube to length therefrom;
characterized in that a capillary bore is subjected in the heating zone to a shrinkage process based on the action of draw temperature T_{draw} and surface tension in such a way that the diameter ratio dᵣₑₗ of the capillary strand is adjusted to a value greater than the diameter ratio Dᵣₑₗ of the preform by at least a factor of 5, and wherein a multimode optical fiber preform or a single-mode optical fiber preform with a preform core surrounding an inner bore and a preform cladding covering the preform core is employed as the preform, and a capillary strand is drawn therefrom having a capillary core surrounding a capillary bore and a capillary cladding covering the capillary core.

2. The method according to claim 1, characterized in that the draw temperature T_{draw} causing the shrinkage process is determined in an iterative process comprising:
(a) heating the heating zone to a temperature T₁, wherein T₁<T_{draw} applies;
(b) drawing a partial capillary strand with the heating zone heated to the temperature T₁;
(c) determining and ensuring the capillary bore diameter of the partial capillary strand is greater than a nominal inner diameter of the capillary bore;
(d) The temperature of the heating zone is raised from T₁ to a draw temperature T₂, and with the heating zone heated to the draw temperature T₂ a further partial capillary strand is drawn.
(e) The capillary bore diameter of the further partial capillary strand is determined and it is established whether the diameter lies within an acceptable fluctuation range of the nominal inner diameter.
(f) If the capillary bore diameter lies within the fluctuation range of the nominal inner diameter, T₂=T_{draw} applies; if the capillary bore diameter is greater than the nominal inner diameter, including the acceptable fluctuation range, T₂<T_{draw} applies and the iterative process is continued in method step (d) with the proviso that T₁=T₂; if the capillary bore diameter is less than the nominal inner diameter including the fluctuation range, T₂>T_{draw} applies and the iterative process is continued in method step (a).

3. The method according to claim 2, characterized in that, in (c) and (e), the determination of the diameter of the capillary bore takes place during the drawing of the capillary strand or during the drawing of the further capillary strand, as applicable.

4. The method according to claim 1, characterized in that the draw speed v_{draw} is adjusted to be in the range of 5 to 100 m/min.

5. The method according to claim 1, characterized in that the capillary strand is drawn off with an elongation ratio in the range of 900 to 200,000.

6. The method according to claim 1, characterized in that the following apply to the preform and to the capillary strand:
D_{OD}>15 mm
D_{ID}>1 mm
Dᵣₑₗ<30
d_{OD}>100 μm
d_{ID}<1 μm
dᵣₑₗ>100

7. The method according to claim 1, characterized in that the following applies to the capillary strand:
100 μm < d_{OD} < 500 μm,
0.1 μm < d_{ID} < 1 μm and
100 < dᵣₑₗ < 5000.

8. The method according to claim 1, characterized in that the following applies to the preform:
15 mm < D_{OD} < 45 mm,
1,000 μm < D_{ID} < 5,000 μm and
3 < Dᵣₑₗ < 30.

9. The method according to claim 1, characterized in that the following applies to preform and capillary strand:
2,000 < D_{ID}/d_{ID} < 50,000
dᵣₑₗ/Dᵣₑₗ > 50 and
dᵣₑₗ/Dᵣₑₗ < 300.

10. The method according to claim 1, characterized in that the heating zone is formed in a tube furnace having a circular inner heating chamber.

11. The method according to claim 1, characterized in that the capillary core has a cross-sectional area CSA_{KK} and the capillary cladding has a cross-sectional area CSA_{KM}, wherein a preform is employed in which the preform core has a cross-sectional area CSA_{VK} and the preform cladding has a cross-sectional area CSA_{VM}, wherein the following applies to the respective cross-sectional area ratios of cladding and core: CSA_{KM}/CSA_{KK}=CSA_{VM}/CSA_{VK}.

12. A capillary tube composed of glass having an outer diameter d_{OD} and an inner diameter d_{ID}, obtained by a method of claim 1, wherein the following applies:
100 μm < d_{OD} < 500 μm,
0.1 μm < d_{ID} < 1 μm and
100 < dᵣₑₗ < 5000, with dᵣₑₗ = d_{OD}/d_{ID}.
